(19) United States
(12) Patent Application Publication
(10) Pub. No.: US 2022/0294338 A1
(43) Pub. Date: Sep. 15, 2022

(54) CHARGER FOR IN PLUG-IN ELECTRIC VEHICLES

(71) Applicants: Hua BAI, Knoxville, TN (US); Liyan ZHU, Knoxville, TN (US); Wolfgang BAECK, Sankt Valentin (AT); Michael NEUDORFHOFER, Sankt Valentin (AT); Gerd SCHLAGER, Sankt Valentin (AT); Lakshmi Varaha IYER, Troy, MI (US); Philip KORTA, Troy, MI (US)

(72) Inventors: Hua BAI, Knoxville, TN (US); Liyan ZHU, Knoxville, TN (US); Wolfgang BAECK, Sankt Valentin (AT); Michael NEUDORFHOFER, Sankt Valentin (AT); Gerd SCHLAGER, Sankt Valentin (AT); Lakshmi Varaha IYER, Troy, MI (US); Philip KORTA, Troy, MI (US)

(21) Appl. No.: 17/635,835

(22) PCT Filed: Aug. 14, 2020
(86) PCT No.: PCT/US2020/046344

§ 371 Date: Feb. 16, 2022

Related U.S. Application Data
(60) Provisional application No. 62/887,910, filed on Aug. 16, 2019.

(51) Int. Cl. H02M 1/42; B60L 53/30

(52) U.S. Cl. CPC H02M 1/4233; B60L 53/30; H02M 7/219

(57) ABSTRACT

A battery charger for an electric vehicle supplies DC output power to an output bus for supplying power to a battery. The battery charger includes an AC/DC converter using switches to convert AC power from an AC source to a DC link voltage upon a DC link bus. A DC link capacitor allows a ripple in the DC link voltage that is greater than in conventional charger designs. A DC/DC stage includes a DC/AC converter including one or more switches to selectively conduct current from the DC link bus to supply an AC power to a transformer. The switches of the DC/AC converter are mounted to an insulated metal substrate that is in thermal contact with a transformer housing for dissipating heat therefrom. A controller controls one or more switches of the DC/AC converter and varies a switching frequency responsive to the ripple of the DC link voltage.

### CROSS-REFERENCE TO RELATED APPLICATIONS

This PCT International Patent application claims the benefit of and priority to U.S. Provisional Patent Application Ser. No. 62/887,910 filed on Aug. 16, 2019, and titled “Charger For In Plug-In Electric Vehicles,” the entire disclosure of which is hereby incorporated by reference.

### BACKGROUND

Different types and arrangements exist for charging the battery pack of a plug-in electric vehicle (EV) using a stationary source of electric power, typically provided by a connection to the electric grid. Plug-in EV chargers, also called ‘battery chargers’, may be broadly categorized as Level 1, 2 or 3. Level 1 chargers use a standard single-phase outlet (120 VAC in North America) and take the longest time to charge the battery pack among three levels of chargers stated above. Level 2 chargers utilize a higher supply voltage (240 VAC in North America) and are typically sold by the auto manufacturers or other electrical supply equipment manufacturers for an additional cost ranging between $1000 and $3000. Level 2 charging usually takes between 2-4 hours to charge the battery pack of a typical plug-in EV.

Plug-in EV chargers may be integrated with an EV and/or provided as stand-alone units. Size and weight of Plug-in EV chargers are important considerations. This is especially true for chargers that are integrated with or otherwise transported with the EV.

### SUMMARY

The present disclosure provides a battery charger for an electric vehicle, comprising an AC/DC converter configured to convert AC power from an AC source to a DC power upon a DC link bus including a DC positive node and a DC negative node and defining a DC link voltage therebetween. The DC link voltage has a ripple as a periodic variation. The battery charger also includes a DC/DC stage including a switch configured to selectively conduct current from the DC link bus to convert the DC power from the DC link bus to an output DC power having an output voltage different from the DC link voltage. The battery charger also includes a controller configured to control the switch and to vary at least one of a switching frequency or a duty cycle or a phase shift of the switch responsive to the ripple of the DC link voltage.

The present disclosure also provides a method of operating a battery charger. The method comprises commanding a switch to selectively conduct current from a DC link bus to convert a DC power from the DC link bus to an output DC power having an output voltage different from the DC link voltage; and varying at least one of a switching frequency or a duty cycle or a phase shift of the switch responsive to a ripple of a DC link voltage upon the DC link bus.

### BRIEF DESCRIPTION OF THE DRAWINGS

Further details, features and advantages of designs of the invention result from the following description of embodiment examples in reference to the associated drawings.

FIG. 1 shows a schematic block diagram of a battery charger in accordance with some embodiments of the present disclosure;

FIG. 2 shows a schematic diagram of a battery charger in accordance with some embodiments of the present disclosure;

FIG. 3 shows graphs of DC bus voltage and DC bus current over time;

FIG. 4 shows a composite graph of grid voltage and grid current over time;

FIG. 5 shows a functional diagram illustrating operation of a DC-DC stage in accordance with some embodiments of the present disclosure;

FIG. 6 shows a top view of a battery charger in accordance with some embodiments of the present disclosure;

FIG. 7 shows a perspective view of a battery charger in accordance with some embodiments of the present disclosure;

FIG. 8 shows a perspective view of a battery charger in accordance with some embodiments of the present disclosure;

FIG. 9 shows a perspective view showing temperatures of various parts of a battery charger in accordance with some embodiments of the present disclosure;

FIG. 10 shows a top view showing temperatures of various parts of a battery charger in accordance with some embodiments of the present disclosure;

FIG. 11 shows a front side view showing temperatures of various parts of a battery charger in accordance with some embodiments of the present disclosure;

FIG. 12 shows a side view showing temperatures of various parts of a battery charger in accordance with some embodiments of the present disclosure; and

FIG. 13 shows a flow chart of steps in a method of operating a battery charger in accordance with some embodiments of the present disclosure.

### DETAILED DESCRIPTION

Referring to the drawings, the present invention will be described in detail in view of following embodiments.

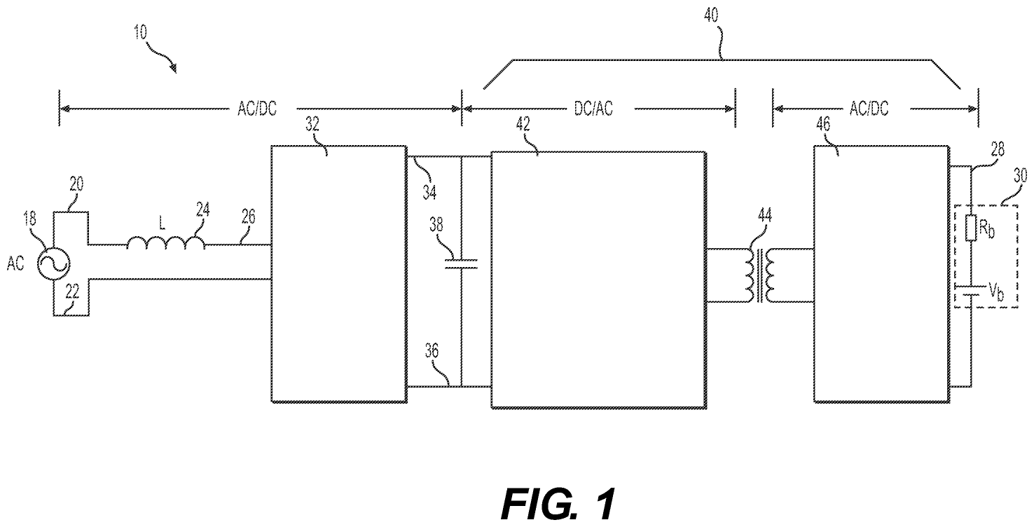

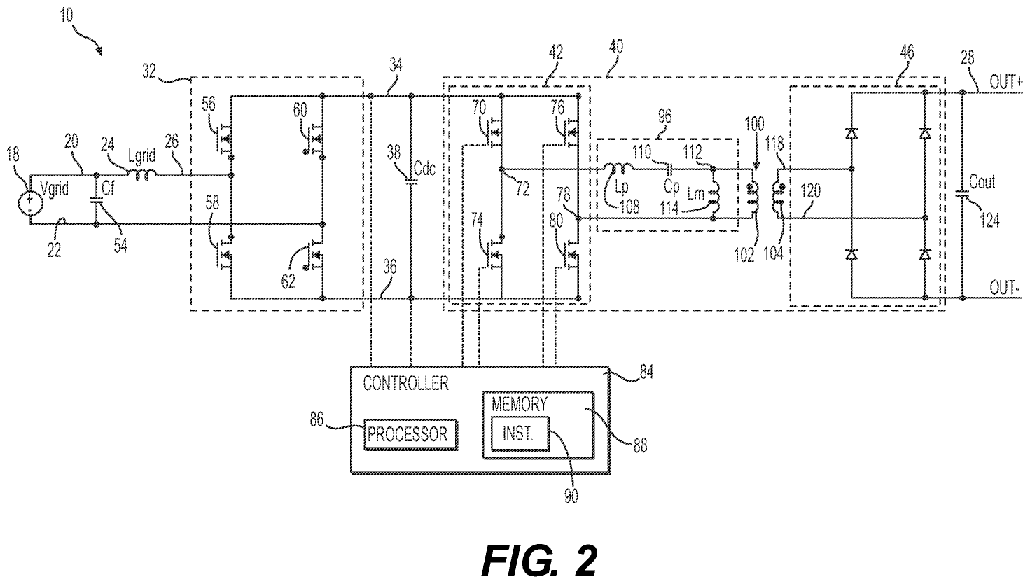

FIGS. 1-2 each show schematic diagrams of a battery charger 10 for an electric vehicle which is configured to provide DC output power to an output bus 28 for supplying a load 30, such as a battery, using AC power obtained from an AC source 18, which may be a grid or utility line power supply. The battery charger 10 of the present disclosure may be an onboard device, having all or most of its components located within and movable with the electric vehicle. Alternatively, the battery charger 10 of the present disclosure may be located outside of the vehicle. For example, the battery charger 10 may be located at a fixed charging station installation. In some embodiments, and as shown in FIGS. 1-2, the AC source 18 is a single phase source providing AC grid voltage V_{grid} between a first input conductor 20, which may be called a line conductor (L1) and a second input conductor 22, which may be called a neutral conductor (N). However, the AC source 18 may have other configurations, such as a 3-phase supply, or a different single phase configuration, such as a 240V single phase system with two conductors each carrying an AC voltage that is 180-degrees out of phase with one another, as is commonly provided in North American residential and light commercial service. The load 30 shown in FIG. 1 is a simplified model of a battery including a battery voltage V_{b} and a model battery resistance R_{b}.

In some embodiments, and as shown in FIG. 1, an input inductor 24, which may also be called a grid inductor, is connected between the first input conductor 20 and a first line node 26. The input inductor 24 has an inductance L_{grid} and may help to regulate the voltage and/or current supplied by the AC source 18 and may function to reduce electromagnetic interference (EMI).

Still referring to FIG. 1, the battery charger 10 includes a first AC/DC converter 32 configured to convert AC power from the AC source 18 to a DC power upon a DC link bus 34, 36. Specifically, the DC link bus 34, 36 includes a DC positive node 34 and a DC negative node 36 defining a DC link voltage V_{DC_BUS} therebetween. A DC link capacitor 38 having a capacitance value C_{dc} is connected between the DC positive node 34 and the DC negative node 36 for regulating and stabilizing the DC link voltage V_{DC_BUS}. The battery charger 10 also includes a DC/DC stage 40 having a DC/AC converter 42 that supplies an AC power to a transformer 44. The DC/DC stage 40 also includes a second AC/DC converter 46 configured to convert AC power from a secondary side of the transformer 44 to energize the output bus 28 with DC power.

In some embodiments, the DC link voltage V_{DC_BUS} has a ripple as a periodic variation. The ripple may have a frequency that is two times the frequency of the AC source 18. The ripple may be sinusoidal, although other waveform shapes are possible. In conventional converter designs, ripple is sought to be minimized. However, in some embodiments of the present disclosure, the ripple of the DC link voltage V_{DC_BUS} is allowed to have a greater amplitude than in conventional designs. In some embodiments, for example, the DC link voltage V_{DC_BUS} may fluctuate between 330 V and 410V, providing a peak-to-peak ripple of 80 V. The size of the DC link capacitor 38 is a main factor in determining the amplitude of the ripple of the DC link voltage V_{DC_BUS}. In some embodiments of the present disclosure, the DC link capacitor 38 has a value of 100 μF to provide the peak-to-peak ripple of 80 V, wherein a conventional design may have a value of 500 μF to provide the peak-to-peak ripple that is substantially less than 80 V. In some embodiments, the DC link voltage V_{DC_BUS} is not regulated by an active filter. In other words, there may be no switches or other actively-controlled devices used to actively regulate the DC link voltage V_{DC_BUS}.

FIG. 2 shows a schematic diagram of a battery charger 10 in accordance with some embodiments of the present disclosure. Specifically, FIG. 2 shows additional internal details of the first AC/DC converter 32, and the DC/DC Stage 40 in accordance with some example embodiments. In some embodiments, and as shown in FIG. 2, an input capacitor 54, which may also be called a grid capacitor or a filter capacitor, has a capacitance value Cf and is connected between the first input conductor 20 and the second input conductor 22. The input capacitor 54 may help to regulate the voltage and/or current supplied by the AC source 18 and may function to reduce electromagnetic interference (EMI).

In some embodiments, and as shown in FIG. 2, the first AC/DC converter 32 is configured as a power factor correction (PFC) stage, which uses switches, such as switching transistors, to convert the AC power from the AC source 18 to a DC power upon the DC link bus 34, 36 while providing a power factor that is substantially close to unity (1.0). In other words, the PFC stage may appear to the AC source 18 as, or close to, a purely resistive load. The first AC/DC converter 32 includes a first high switch 56 configured to selectively conduct current between the first line node 26 and the DC positive node 34 of the DC link bus 34, 36. The first AC/DC converter 32 also includes a first low switch 58 configured to selectively conduct current between the first line node 26 and the DC negative node 34 of the DC link bus 34, 36. The first high switch 56 and the first low switch 58 may each operate at a fast switching frequency, which may be, for example, 100 kHz. Together, the first high switch 56 and the first low switch 58 may be called a fast leg 56, 58 of the first AC/DC converter 32.

The first AC/DC converter 32 also includes a second high switch 60 configured to selectively conduct current between the second input conductor 22 and the DC positive node 34 of the DC link bus 34, 36, and a second low switch 62 configured to selectively conduct current between the second input conductor 22 and the DC negative node 34 of the DC link bus 34, 36. The second high switch 60 and the second low switch 62 may each operate at a slow switching frequency that may match the frequency of the AC source, for example, 60 Hz. Together, the second high switch 60 and the second low switch 62 may be called a slow leg 60, 62 of the first AC/DC converter 32. The switches 56, 58, 60, 62 of the first AC/DC converter 32 may be negative type Metal Oxide Semiconductor (NMOS) type field effect transistors (FETs), as shown. However, one or more of the switches may 56, 58, 60, 62 may be different types of devices, such as another type of FET, a junction transistor, or a triac.

Still referring to FIG. 2, the battery charger 10 includes the DC/DC stage 40 having one or more switches 70, 74, 76, 80 that are configured to selectively conduct current from the DC link bus 34, 36 to convert the DC power from the DC link bus 34, 36 to an output DC power having an output voltage Vₒᵤₜ different from the DC link voltage V_{DC_BUS}. The battery charger 10 also includes a controller 84 configured to control the switches 70, 74, 76, 80 and to vary at least one of a switching frequency or a duty cycle or a phase shift of the switch responsive to the ripple of the DC link voltage V_{DC_BUS}. More specifically, the controller 84 includes a processor 86 and a machine readable storage memory 88 holding instructions 90 for execution by the processor 86 to cause the processor 86 to command one or more of the switches 70, 74, 76, 80 selectively conduct current from the DC link bus 34, 36 responsive to the ripple of the DC link voltage V_{DC_BUS}. The processor 86 may include one or more of a microprocessor, a microcontroller, a programmable gate array, or an application specific integrated circuit (ASIC).

In some embodiments, and as shown in FIG. 2, the DC/DC stage 40 includes the DC/AC converter 42 that is configured to generate an AC current by switching currents from the DC link bus 34, 36. Specifically, the DC/AC converter 42 includes a first positive switch 70 configured to selectively conduct current between the DC positive node 34 and a first internal node 72, and a first negative switch 74 configured to selectively conduct current between the DC negative node 36 and the first internal node 72. The DC/AC converter 42 also includes a second positive switch 76 configured to selectively conduct current between the DC positive node 34 and a second internal node 78, and a second negative switch 80 configured to selectively conduct current between the DC negative node 36 and the second internal node 78. The switches 70, 74, 76, 80 of the DC/AC converter 42 may be negative type Metal Oxide Semiconductor (NMOS) type field effect transistors (FETs), as shown. However, one or more of the switches may 56, 58, 60, 62 may be different types of devices, such as another type of FET, a junction transistor, or a triac.

The first and second internal nodes 72, 78, thus carry the AC current that is converted to a different voltage level by an inductor-inductor-capacitor (LLC) resonant tank 96 and the transformer 100 having a primary winding 102 secondary winding 104. The transformer windings 102, 104 may have a 1:1 ratio, as shown in FIG. 2, although other turns ratios may be used. The resonant tank 96 includes a resonant inductor 108 having an inductance value Lp and a resonant capacitor 110, having a capacitance value Cp. The resonant inductor 108 and the resonant capacitor 110 are wired in series with one another and between the first internal node 72 and a third internal node 112. A magnetizing inductance 114 having an inductance value Lm, and the primary winding 102 of the transformer 100 are each connected between the second internal node 78 and the third internal node 112. The magnetizing inductance 114 may be a stand-alone device and/or a functional characteristic of the primary winding 102 of the transformer 100. In some embodiments, and particularly where the DC/DC Stage 40 includes an inductor-inductor-capacitor (LLC) resonant tank 96, a switching frequency of the switch 70, 74, 76, 80 may be varied in response to the ripple of the DC link voltage V_{DC_BUS} upon the DC link bus 34, 36.

The secondary winding 104 of the transformer 100 defines a first secondary node 118 and a second secondary node 120 having an AC voltage induced thereupon by magnetic flux induced by AC current in the primary winding 102. The second AC/DC converter 46 is configured to rectify the AC voltage from the first and second secondary nodes 118, 120 and to provide the output voltage V_{OU}T upon the output bus 28. The second AC/DC converter 46 may include four diodes connected as a bridge rectifier, as shown in FIG. 2. However, the second AC/DC converter 46 may have other configurations, such as a single diode, a wave rectifier, and/or one or more switches configured to provide active rectification, which may also be called synchronous rectification (SR). In some embodiments, and as shown in FIG. 2, an output capacitor 124 may be connected across the output bus 28 for smoothing the output voltage V_{OUT}.

In some embodiments, (not shown in the drawings), the DC/DC Stage 40 may comprise a dual active bridge (DAB) type converter including a first active bridge that includes one or more switches configured to supply a DC current directly to the primary winding 102 of the transformer 100. In some embodiments, the first active bridge may be similar or identical to the DC/AC converter 42 described above with reference to FIG. 2. In other words, a DAB type converter may not include any resonant tank 96 between the first active bridge and the transformer 100. The DAB type converter may also include a second active bridge configured to rectify the AC current from the secondary winding 104 of the transformer 100 as the DC output power upon the output bus 28. In some embodiments, and particularly where the DC/DC Stage 40 includes a dual active bridge (DAB) type converter, a phase shift of the switch 70, 74, 76, 80 may be varied in response to a ripple of a DC link voltage V_{DC_BUS} upon the DC link bus 34, 36.

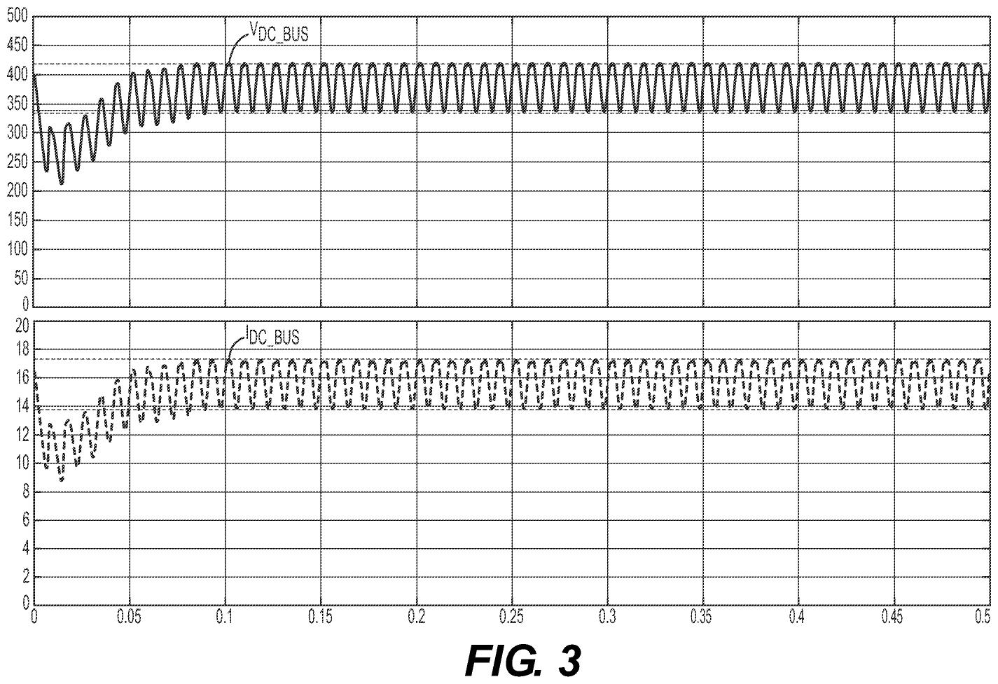

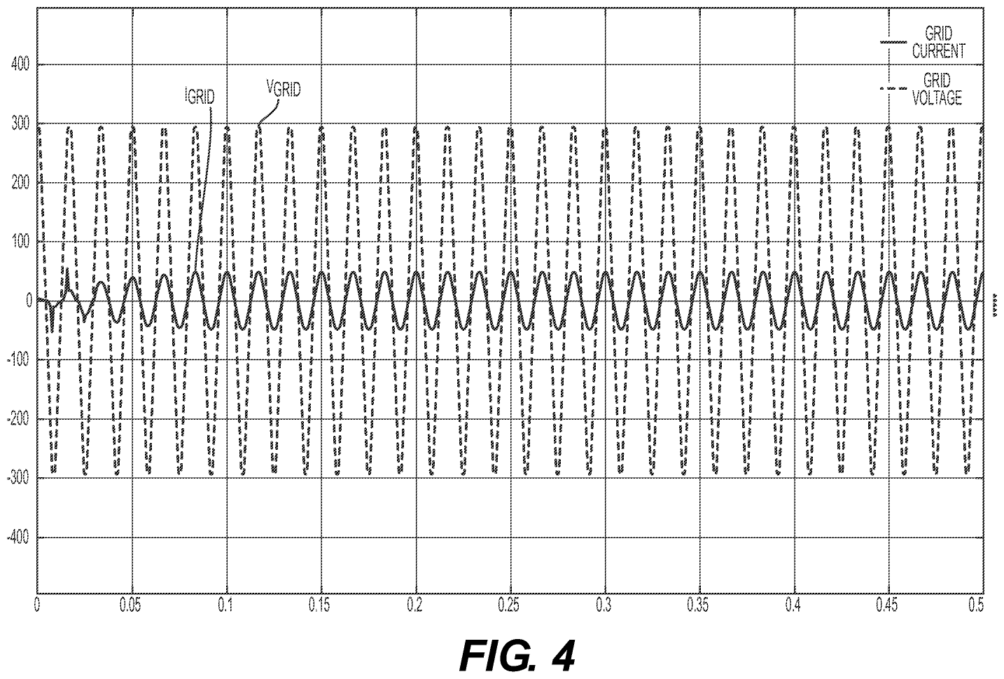

FIG. 3 shows graphs of the DC link voltage V_{DC_BUS} and DC bus current I_{DC_BUS} over time, and FIG. 4 shows a composite graph of the AC grid voltage V_{GRID} and AC grid current I_{GRID} supplied to the battery charger 10 by the AC source 18 the over time.

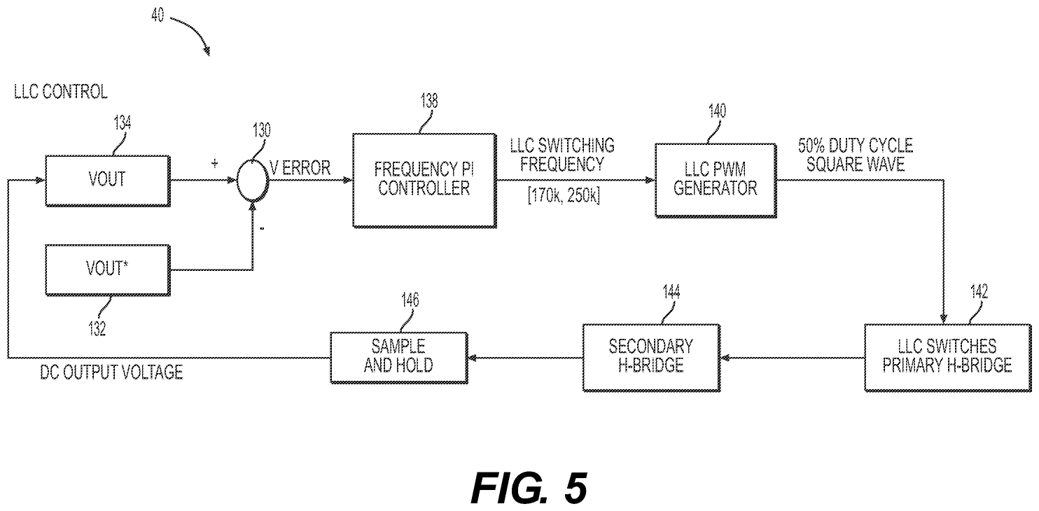

FIG. 5 shows a functional diagram illustrating operation of a DC-DC stage 40 in accordance with some embodiments of the present disclosure. Specifically, FIG. 5 shows a summing block 130 configured to subtract a reference voltage 132 from an actual output voltage 134 to produce a voltage error signal Vₑᵣᵣₒᵣ. The voltage error signal Vₑᵣᵣₒᵣ is sent to a frequency proportional-integral (PI) controller 138 that generates an LLC switching frequency based upon the voltage error signal Vₑᵣᵣₒᵣ over time. In some embodiments, the LLC switching frequency may vary between 170 kHz and 250 kHz, although other frequencies may be used. The LLC switching frequency is provided to an LLC PWM Generator 140 that generates a pulse-width modulated (PWM) signal. The pulse-width modulated (PWM) signal may be configured as a 50% duty cycle square wave. The pulse-width modulated (PWM) signal is provided to a primary H-Bridge which may include, for example, the a first positive switch 70 and the first negative switch 74 of the DC/AC converter 42 described above with reference to FIG. 2. The pulse-width modulated (PWM) signal is provided to a primary H-Bridge 142 which may include, for example, the first positive switch 70 and the first negative switch 74 of the DC/AC converter 42 described above with reference to FIG. 2. The pulse-width modulated (PWM) signal is also provided to a secondary H-Bridge 144 which may include, for example, the second positive switch 76 and the second negative switch 80 of the DC/AC converter 42 described above with reference to FIG. 2. The DC-DC stage 40 may also include an output voltage monitor 146 that may be configured to periodically sample and hold a value of the output voltage V_{OUT} to generate the actual output voltage signal 134.

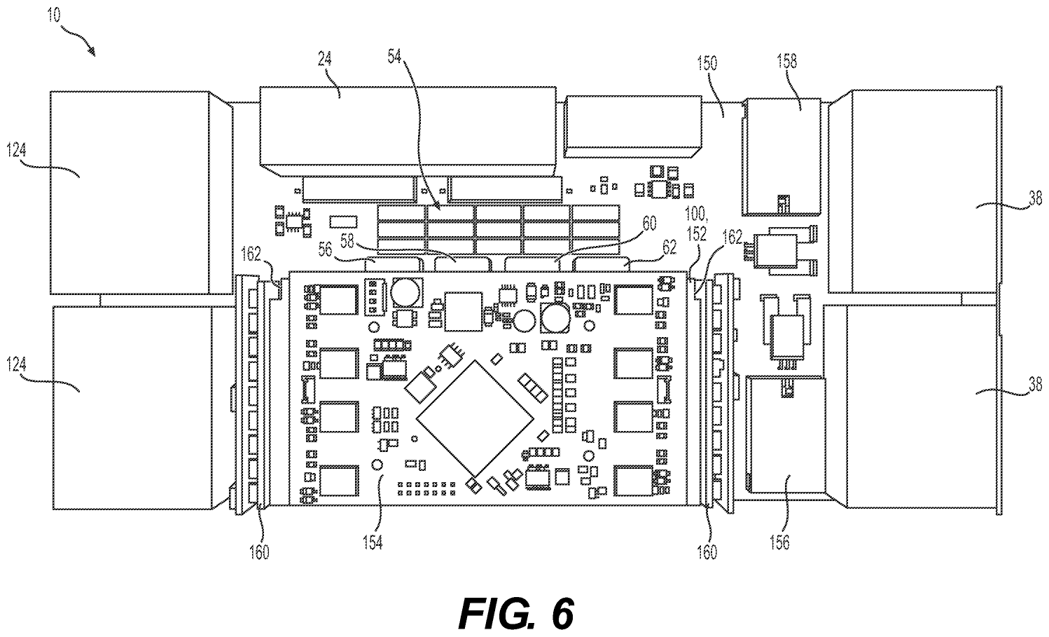

FIG. 6 shows a top view of a battery charger 10 in accordance with some embodiments of the present disclosure. Specifically, FIG. 6 shows a main board 150, such as a printed circuit board, extending in a flat plane and holding a transformer housing 152 that includes the transformer 100. The transformer housing 152 may include an enclosure of metal, such as aluminum, or another heat conductive material. An electronic control unit (ECU) board 154 is disposed over the transformer 100, with the transformer 100 disposed between the main board 150 and the ECU board 154. The ECU board may contain the processor 86 and/or other electronic devices and components. An input terminal connector 156 and an output terminal connector 158 are each disposed upon the main board 150 to provide electrical connections for the AC source 18 and the output bus 28, respectively. Two DC link capacitors 38 are disposed upon the main board 150 adjacent to the terminal connectors 156, 158, and two output capacitors 124 are disposed upon the main board 150 opposite from the DC link capacitors 38. The input inductor 24 is disposed upon the main board 150 and is shown as a large box near the top of FIG. 6. An array of fifteen individual devices are disposed upon the main board 150 and together comprise the input capacitor 54, which may also be called the “grid side capacitor.” The four switches 56, 58, 60, 62 of the first AC/DC converter 32 are shown extending upwardly from the main board 150 between the transformer 100 and the input capacitor 54.

In some embodiments, the switches 70, 74, 76, 80 of the DC/DC stage 40 are each mounted to an insulated metal substrate (IMS) 160 that is in thermal contact with the transformer housing 152. For example, one or more of the switches 70, 74, 76, 80 may be soldered to the insulated metal substrate 160. Waste heat from operation of the switches 70, 74, 76, 80 may, therefore, be conducted through the IMS 160 and to the transformer housing 152, from which the heat may be removed. The heat may be further dissipated from the transformer housing 152 by one or more heat sinks in thermally-conductive contact with the transformer housing 152.

In some embodiments, and as shown in FIG. 6, the insulated metal substrates 160 are each disposed on a side wall 162 of the transformer housing 152 perpendicular to the main board 150. This configuration may simplify wiring connections between the main board 150 and the switches 70, 74, 76, 80 on the insulated metal substrates 160, thereby making the assembly more compact.

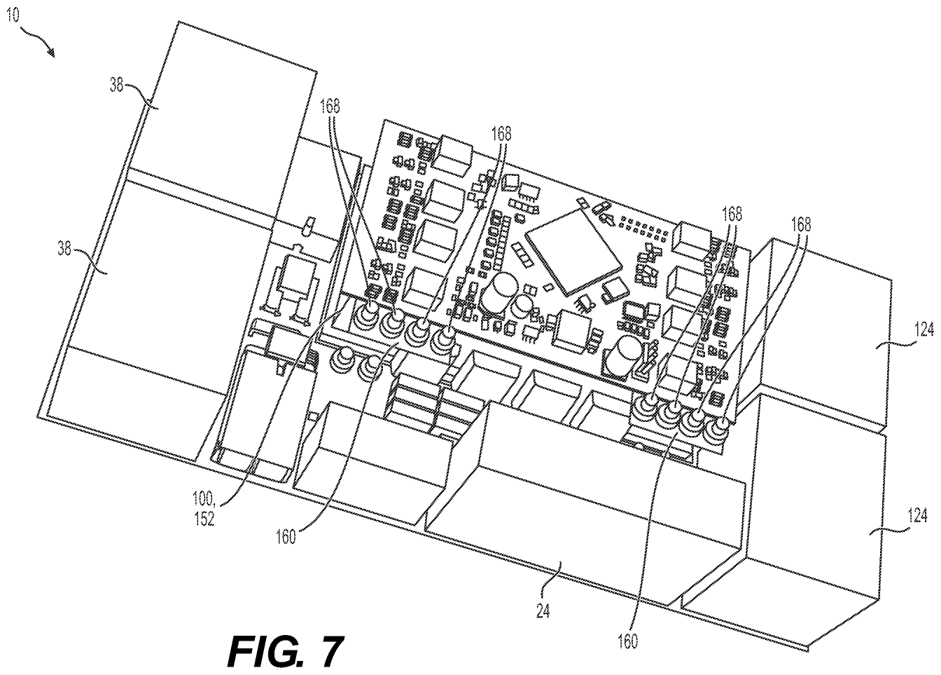

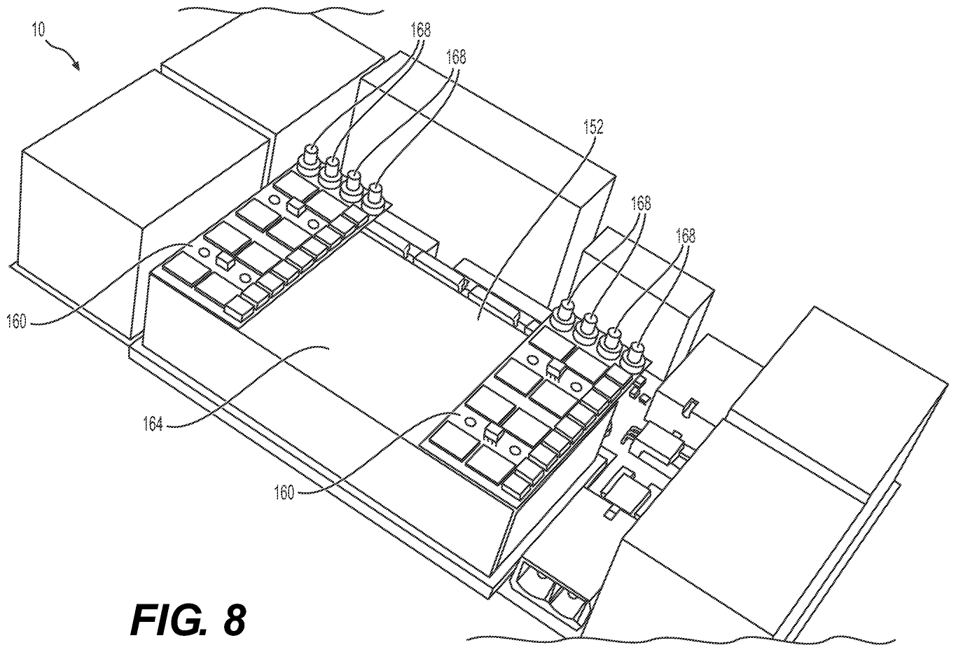

In some embodiments, and as shown in FIGS. 7-8, the insulated metal substrates 160 are each disposed on an upper portion 164 of the transformer housing 152 spaced apart from and parallel to the main board 150. In some embodiments, and as shown in FIGS. 7-8, screws and/or bolts 168 are used as conductors for connecting insulated metal substrates 160 with the switches 70, 74, 76, 80 of the DC/DC stage 40 to the respective primary windings of the transformer 100. FIG. 8 is a rotated view of the battery charger 10 of FIG. 8, but with the ECU board 154 removed to show details of the insulated metal substrates 160 below.

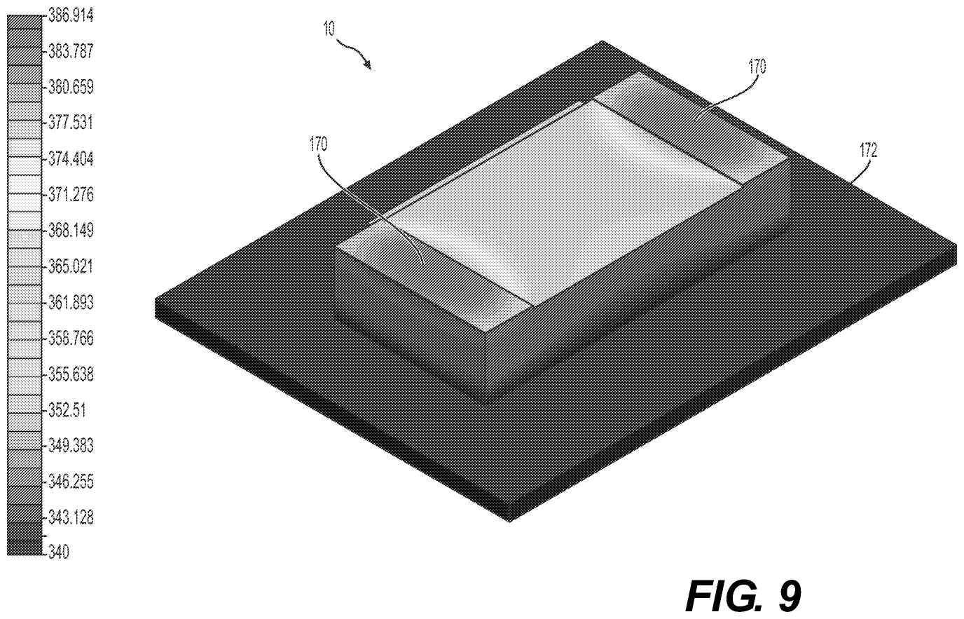

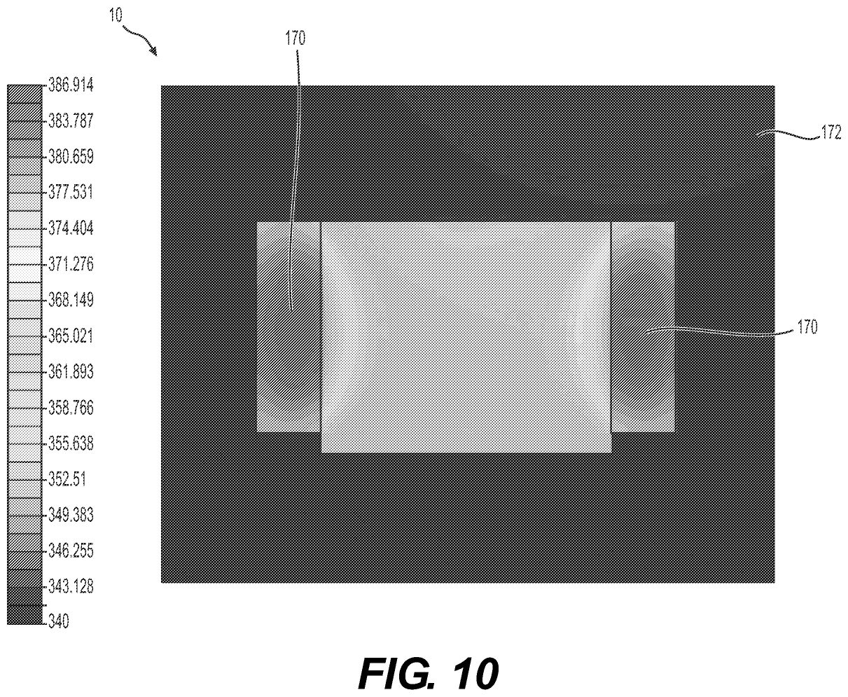

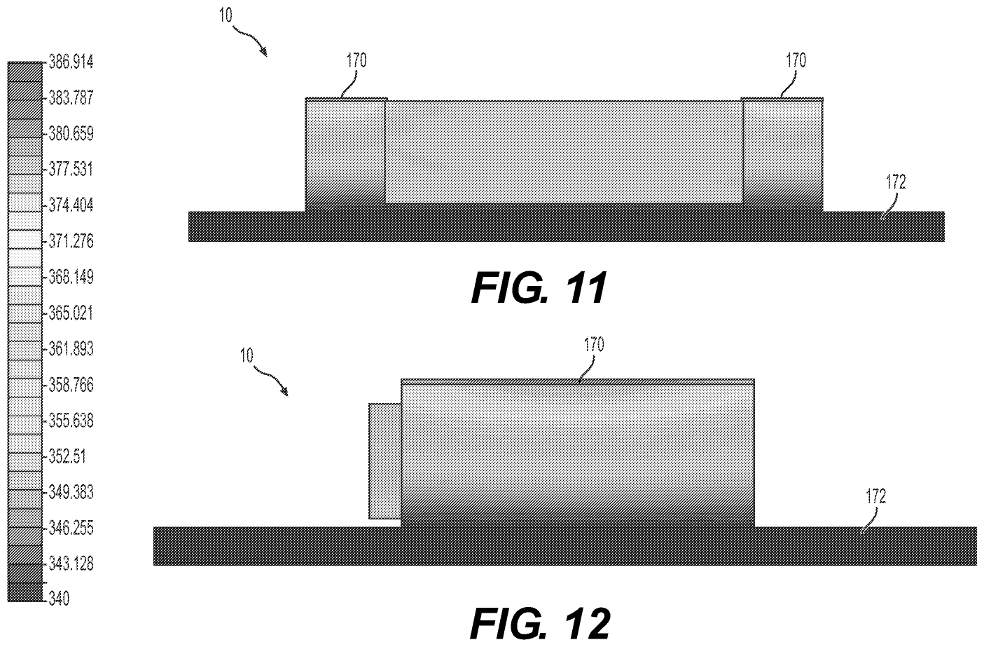

FIGS. 8-12 each show different views of the battery charger 10 of FIGS. 7-8, illustrating different temperatures from hottest regions 170 at and/or near the insulated metal substrates 160 to coldest regions at or near the main board 150. FIGS. 8-12 show the maximum temperature happens at the switches 70, 74, 76, 80 (387K=114° C.), which is much lower than a 150 C limit where the switches 70, 74, 76, 80 are Gallium nitride (GaN) devices.

The battery charger 10 of the present disclosure may be significantly smaller and/or lighter weight than conventional converters that have similar power converting capacity. These savings may be realized by a combination of: 1) reducing the size of the DC link capacitor 38 and 2) attaching the IMS 160 to the transformer housing 152.

In some embodiments, a battery charger 10 constructed in accordance with the present disclosure may have a size (without electrical connectors) of 2.45*1.18*0.5 dm³=1.45 L, yielding a power density of 6.6/1.45=4.56 kW/L, in contrast to other convers of similar capacity on the market, which have a power density of less than 2.0 kW/L.

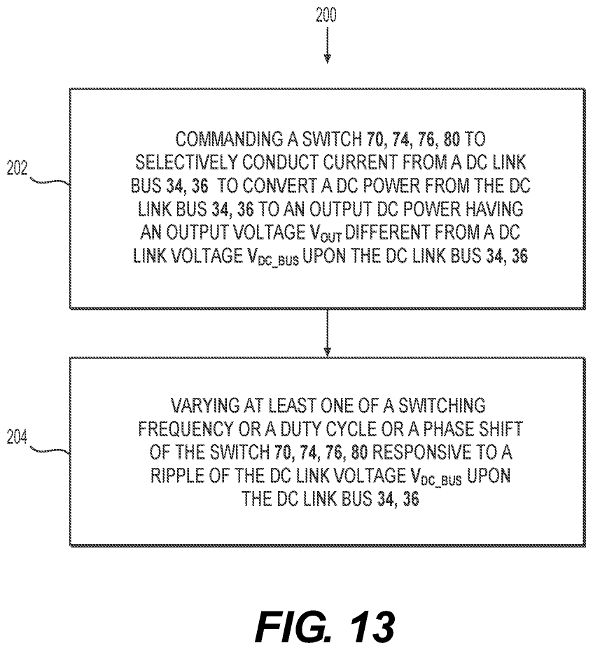

A method 200 of operating a battery charger is shown in the flow chart of FIG. 13. The method 200 includes commanding a switch 70, 74, 76, 80 to selectively conduct current from a DC link bus 34, 36 to convert a DC power from the DC link bus 34, 36 to an output DC power having an output voltage V_{OUT} different from the DC link voltage V_{DC_BUS} upon the DC link bus 34, 36 at step 202.

The method 200 also includes varying at least one of a switching frequency or a duty cycle or a phase shift of the switch 70, 74, 76, 80 responsive to a ripple of a DC link voltage V_{DC_BUS} upon the DC link bus 34, 36 at step 204. Step 204 may include varying the switching frequency of the switch 70, 74, 76, 80 by operating the switching frequency at a low frequency less than a nominal frequency in response to the DC link voltage V_{DC_BUS} being less than a nominal voltage, and operating the switching frequency at a high frequency greater than the nominal frequency in response to the DC link voltage V_{DC_BUS} being greater than the nominal voltage. For example, the switching frequency may vary between a low frequency that is 50 kHz below a nominal frequency of 200 kHz (i.e. 150 kHz), and a high frequency that is 50 kHz above the nominal frequency (i.e. 250 kHz).

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A battery charger for an electric vehicle, comprising:
an AC/DC converter configured to convert AC power from an AC source to a DC power upon a DC link bus including a DC positive node and a DC negative node and defining a DC link voltage therebetween, the DC link voltage having a ripple as a periodic variation;
a DC/DC stage including a switch configured to selectively conduct current from the DC link bus to convert the DC power from the DC link bus to an output DC power having an output voltage different from the DC link voltage; and
a controller configured to control the switch and to vary at least one of a switching frequency or a duty cycle or a phase shift of the switch responsive to the ripple of the DC link voltage.

2. The battery charger of claim 1, wherein the controller is configured to vary the switching frequency of the switch responsive to the ripple of the DC link voltage.

3. The battery charger of claim 1, wherein the controller is configured to vary the switching frequency of the switch from a low frequency less than a nominal frequency in response to the DC link voltage being less than a nominal voltage to a high frequency greater than the nominal frequency in response to the DC link voltage being greater than the nominal voltage.

4. The battery charger of claim 3, wherein the switching frequency of the switch is determined by a proportional-integral (PI) controller based upon the DC link voltage.

5. The battery charger of claim 3, wherein the low frequency is 50 kHz below the nominal frequency, and the high frequency is 50 kHz above the nominal frequency.

6. The battery charger of claim 3, wherein the nominal frequency is 200 kHz.

7. The battery charger of claim 1, wherein the controller is configured to vary the duty cycle of the switch responsive to the ripple of the DC link voltage.

8. The battery charger of claim 1, wherein the controller is configured to vary the phase shift of the switch responsive to the ripple of the DC link voltage.

9. The battery charger of claim 1, further comprising:
a DC link capacitor connected between the DC positive node and the DC negative node of the DC link bus to regulate the ripple of the DC link voltage.

10. The battery charger of claim 9, wherein the DC link capacitor has a value of less than 500 μF.

11. The battery charger of claim 9, wherein the DC link capacitor has a value of less than 100 μF.

12. The battery charger of claim 1, wherein the DC link voltage is not regulated by an active filter.

13. A method of operating a battery charger comprising:
commanding a switch to selectively conduct current from a DC link bus to convert a DC power from the DC link bus to an output DC power having an output voltage different from the DC link voltage; and
varying at least one of a switching frequency or a duty cycle or a phase shift of the switch responsive to a ripple of a DC link voltage upon the DC link bus.

14. The method of claim 13, wherein varying at least one of the switching frequency or the duty cycle or the phase shift of the switch comprises varying the switching frequency of the switch.

15. The method of claim 14, wherein varying the switching frequency of the switch includes operating the switching frequency at a low frequency less than a nominal frequency in response to the DC link voltage being less than a nominal voltage, and operating the switching frequency at a high frequency greater than the nominal frequency in response to the DC link voltage being greater than the nominal voltage.

16. The method of claim 15, wherein the switching frequency of the switch is determined by a proportional-integral (PI) controller based upon the DC link voltage.

17. The method of claim 15, wherein the low frequency is 50 kHz below the nominal frequency, and the high frequency is 50 kHz above the nominal frequency.

18. The method of claim 15, wherein the nominal frequency is 200 kHz.

19. The method of claim 13, wherein varying the at least one of the switching frequency or the duty cycle or the phase shift of the switch includes varying the duty cycle of the switch responsive to the ripple of the DC link voltage.

20. The method of claim 13, wherein varying the at least one of the switching frequency or the duty cycle or the phase shift of the switch includes varying the phase shift of the switch responsive to the ripple of the DC link voltage.
